(19) United States
(12) Patent Application Publication
(10) Pub. No.: US 2016/0171505 A1
(43) Pub. Date: Jun. 16, 2016

(54) EXTRACT, TRANSFORM, AND LOAD (ETL) PROCESSING

(71) Applicant: Verizon Patent and Licensing Inc., Arlington, VA (US)

(72) Inventors: Siddharth JOHRI, Edison, NJ (US); Paul GERSHTEN, Edgewater, NJ (US); Rajeev Kumar KUNNUMMAL, Cumming, GA (US); Vikrant Narendra VERMA, Cumming, GA (US)

(73) Assignee: VERIZON PATENT AND LICENSING INC.

(21) Appl. No.: 14/572,424

(22) Filed: Dec. 16, 2014

(51) Int. Cl. G06Q 30/00; G06F 17/30; G06Q 10/06

(52) U.S. Cl. CPC G06Q 30/016; G06Q 10/063; G06F 17/30554; G06F 17/30563

(57) ABSTRACT

Systems and methods for an extract, transform and load (ETL) framework are disclosed. Some implementations include retrieving, at a server, chat and call log files from a customer service database, automatically including the chat and call log files into a server database, receiving, one or more queries related to the chat and call log files in the server database, where the queries include one or more of phrase queries or wildcard queries, processing the one or more queries to generate results satisfying the one or more queries, and providing the results of the queries to a client computing device for display, wherein the retrieving, the automatically including, the receiving and the processing are performed in parallel at the server.

### BACKGROUND

In computing, extract, transform, and load (ETL) refers to a process in database usage and especially in data warehousing that extracts data from outside sources, transforms the data to fit operational needs, which can include quality levels, loads the data into an end target database. ETL systems are commonly used to integrate data from multiple applications, typically developed and supported by different vendors or hosted on separate computer hardware. The disparate systems containing the original data are frequently managed and operated by different employees. For example a cost accounting system may combine data from payroll, sales and purchasing. It can be challenging to create an effective ETL process that can process a massive number (e.g., billions) of meta-data elements/tags that may be embedded within documents that are being extracted, transformed and loaded while also enabling search capabilities across such data.

As the foregoing illustrates, a new approach for ETL processing may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a high-level functional block diagram of an exemplary system of networks/devices that provide various communications for mobile stations and support an implementation of the ETL processing framework.

FIG. 2 is a diagram illustrating exemplary ETL interactions in accordance with the disclosed implementations.

FIGS. 3, 4A and 4B illustrate an example data models that are associated with the ETL framework in accordance with the disclosed implementations.

FIGS. 5, 6 and 7 illustrate exemplary tasks performed between different components associated with the Cron jobs of FIG. 2.

FIG. 8 illustrates an exemplary analytics dashboard that may display data provided by the ETL server to a client computing device.

FIG. 9 illustrates an exemplary order confirmation page that may be displayed in the analytics dashboard of FIG. 8.

FIG. 10 illustrates an exemplary order details page that may be displayed in the analytics dashboard of FIG. 8.

FIG. 11 illustrates a simplified functional block diagram of a computer that may be configured as a host or server, for example, to function as the ETL server in the system of FIG. 1.

FIG. 12 illustrates a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various implementations disclosed herein relate to an innovative ETL processing framework. Some implementations include retrieving, at a server, chat and call log files from a customer service database. The retrieved chat and call log files can be automatically stored into a server database. When one or more queries related to the chat and call log files in the server database are received, the queries can be processed to generate results satisfying the queries as the chat and call log files are being extracted, transformed and loaded into the server database. The queries can include one or more of phrase queries or wildcard queries. The results of the queries can be provided to a client computing device for display. The retrieving, the automatically including, the receiving and the processing can be performed in parallel at the server.

In this way, because the above noted operations of retrieving chat and call log files from a customer service database, automatically including the chat and call log files into a server database, receiving, one or more queries related to the chat and call log files in the server database and processing the one or more queries to generate results satisfying the one or more queries can be performed in parallel, the disclosed implementations are able to process a massive amount (e.g., millions) of chat and call records in real time. The disclosed implementations provide an effective ETL process that can process meta-data elements/tags that may be embedded within documents that are being extracted, transformed and loaded while also enabling search capabilities across this data with powerful query types phrase queries, wildcard queries, and sorting by any field. Phrase queries can be queries that can match documents containing a particular sequence of terms. A wildcard query can match documents that have fields matching a wildcard expression. Supported wildcards can include asterisk (*), which matches any character sequence, and question mark (?), which matches any single character. These examples are illustrative and not intended to limit the disclosed implementations.

Reference now is made in detail o the examples illustrated in the accompanying drawings and discussed below.

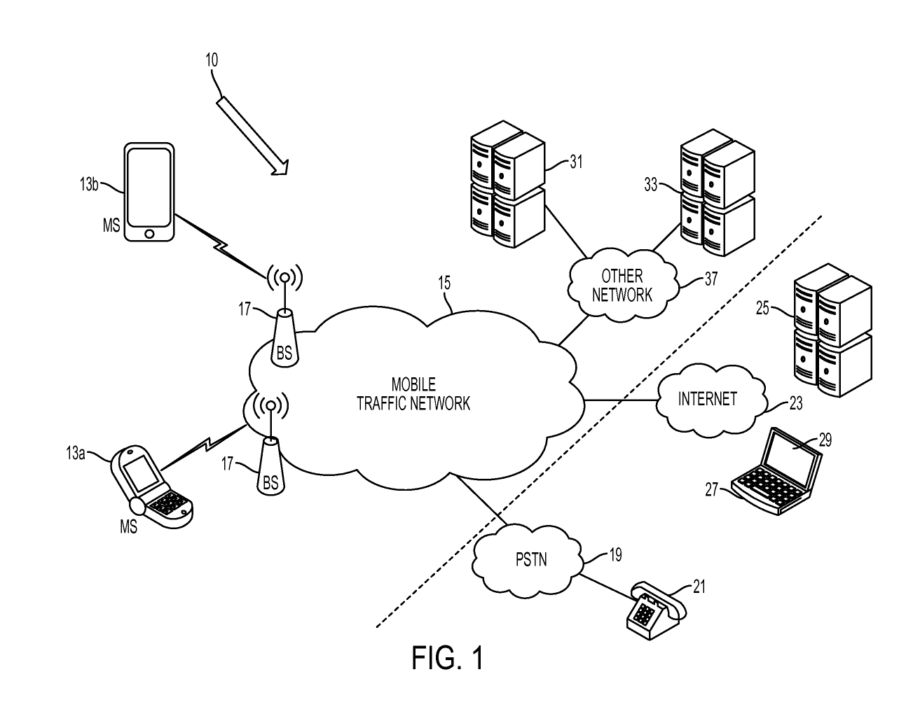

FIG. 1 illustrates a system 10 in which the disclosed implementations may be implemented. The example shows simply two mobile stations (MSs) 13a and 13b as well as a mobile communication network 15. The network 15 provides mobile wireless communications services to those stations as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, the 3rd Generation Partnership Project 2 (3GPP2) wireless IP network standard or the Evolution Data Optimized (EVDO) standard, the Long Term Evolution (LTE) standard, the Global System for Mobile (GSM) communication standard, a time division multiple access (TDMA) standard or other standards used for public mobile wireless communications. The mobile stations 13a and 13b may are capable of voice telephone communications through the network 15 and data communications through the particular type of network 15 (and the users thereof typically will have subscribed to data service through the network).

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a computing device 27 as well as a server 25 connected to the Internet 23; and the data services for the mobile stations 13a and 13b via the Internet 23 may be with devices like those shown at 25 and 27 as well as with a variety of other types of devices or systems capable of data communications through various interconnected networks. The mobile stations 13a and 13 (or any other mobile or non-mobile computing devices) of users of the ETL processing framework also can receive and execute applications written in various programming languages, as discussed more later. In some implementations, the computing device 27 provides a graphical user interface that allows a user to interact with functions provided by ETL server 25. The ETL server 25 is discussed further below.

Mobile stations 13a and 13b and computing device 27 can take the form of portable handsets, smart-phones or personal digital assistants, although they may be implemented in other form factors. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as that serves mobile stations 13a and 13b, can include one or more RANs and a regional circuit and/or packet switched network and associated signaling network facilities.

Physical elements of a RAN operated by one of the mobile service providers or carriers, include a number of base stations represented in the example by the base stations (BSs) 17. Although not separately shown, such a base station 17 can include a base transceiver system (BTS), which can communicate via an antennae system at the site of base station and over the airlink with one or more of the mobile stations 13a and 13b, when the mobile stations 13a and 13b are within range. Each base station can include a BTS coupled to several antennae mounted on a radio tower within a coverage area often referred to as a “cell.” The BTS is the part of the radio network that sends and receives RF signals to/from the mobile stations 13a and 13b that are served by the base station 17.

The radio access networks can also include a traffic network represented generally by the cloud at 15, which carries the user communications and data for the mobile stations 13a and 13b between the base stations 17 and other elements with or through which the mobile stations 13a and 13b communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here for simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 37 (sometimes referred to as an Intranet), i.e., a private networks. Generally, such systems are part of or connected for communication via the private network 37. A person skilled in the art, however, would recognize that systems outside of the private network could serve the same functions as well. Examples of such systems, in this case operated by the network service provider as part of the overall network 10, which communicate through the intranet type network 37, include one or more application servers 31 and a related authentication server 33 for the application service of server 31. A mobile station 13 communicates over the air with a base station 17 and through the traffic network 15 for various voice and data communications, e.g. through the Internet 23 with a server 25 and/or with application servers 31.

Servers such as 25 and 31 may provide any of a variety of common application or service functions in support of or in addition to an application program running on the mobile station 13. However, for purposes of further discussion, we will focus on functions thereof in support of the ETL processing framework. For a given service, including the ETL processing framework, an application program within the mobile station may be considered as a ‘client’ and the programming at 25 or 31 may be considered as the ‘server’ application for the particular service.

As shown by the above discussion, functions relating to the ETL processing framework, via a graphical user interface of computing device 27 (or mobile stations 13a or 13b), may be implemented on computers connected for data communication via the components of a packet data network, operating as an ETL server 25 as shown in FIG. 1. Although special purpose devices may be used, such devices also may be implemented using one or more hardware platforms intended to represent a general class of data processing device commonly used to run “server” programming so as to implement the ETL processing framework discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the ETL processing framework that includes the ETL server 25. The software code is executable by the general-purpose computer that functions as the ETL server 25 and/or that functions as computing device 27 and/or mobile station 13a or 13b. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for the ETL processing framework, in essentially the manner performed in the implementations discussed and illustrated herein.

In some implementations ETL server 25 retrieves chat and call log files from a customer service database. The ETL server 25 may then automatically store the chat and call log files into a server database. The log files may be stored in a Common Log Format. The Common Log Format is a standardized text file format used by web servers when generating server log files. Because the format is standardized, the files can be readily analyzed by a variety of web analysis programs. The ETL server 25 may receive from a client computing device one or more queries related to the chat and call log files in the server database, where the queries include one or more of phrase queries or wildcard queries. The queries received from the client computing device may be parsed by a code formatter. The formatting may involve separating the queries into different lines based on their syntax. The ETL server 25 may then process the one or more queries to generate results satisfying the one or more queries and then provide the results of the queries to a client computing device for display. The above noted steps of retrieving, automatically including, receiving and processing are performed in parallel at the ETL server 25.

In some implementations, the ETL server 25 may perform the retrieving and the automatically including operations at predetermined intervals of time. For example, the operations may be configured to run on an hourly (e.g., every 1 hour) or weekly basis or any other predetermined interval of time. In some implementations, the chat and the call log files include meta-data elements or tags used for the processing of the one or more queries. Meta-data elements are can be tags used documents to provide structured metadata about a page. They can be, for example, a part of a web page's head section. Multiple meta-data elements with different attributes can be used on the same page. Meta-data elements can be used to specify page description, keywords and any other metadata not provided through the other elements and attributes. Metadata elements can also provide information about one or more aspects of data, such as, means of creation of the data, purpose of the data, time and date of creation, creator or author of the data, location on a computer network where the data were created any standards used.

In some implementations, the ETL server 25 reads the retrieved chat and call log files, generates transcriptions of the retrieved chat and call log files and automatically stores the transcriptions into the database. The transcriptions may be conversions of audio files into text files that include content spoken in the audio files.

The ETL server 25 can provide for display to a client computing device a summary of a chat in a dashboard, display chat parameters (e.g. time of chat initiation, chat duration, word count etc.) associated with the chat as a function of time, and display a current status of each chat conversation of the chat, where the current status includes a completed or a canceled status. The completed status may indicate that a chat included a concern that was marked as resolved by a customer service agent. The canceled status may indicate that the chat was canceled by a customer before the concern was resolved by the customer service agent. In some implementations, the ETL server 25 may receive a date range associated with the chat and the call log files, group the chat logs based on the received date range, and display the chat logs based on the grouping in the dashboard. The chat logs may be group alphabetically based on a name of a chat initiator or temporally based on the time at which the chat was initiated. In some implementations, the ETL server 25 determines one or more customer service centers associated with the chat and the call log files and provides for display the chat and the call log files in the user interface with identifications of their customer service centers. The identification may include the location (e.g., city) of a customer service center.

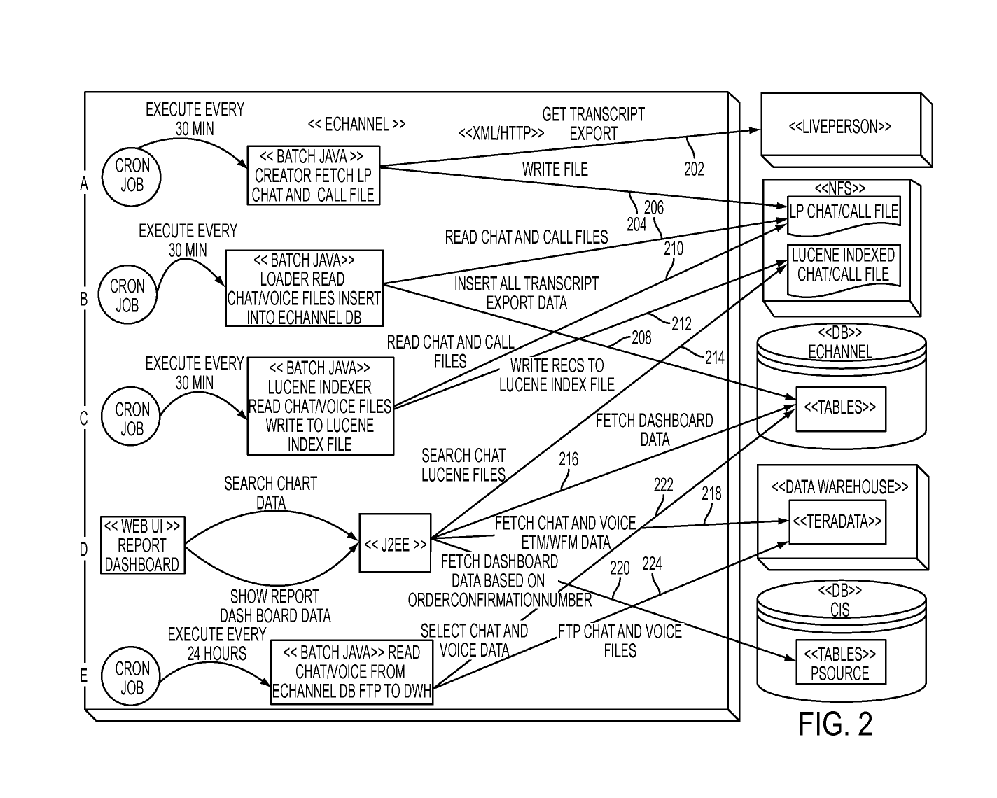

FIG. 2 illustrates an exemplary process flow in accordance with the disclosed implementations. It is to be appreciated that steps in FIG. 2 have been numbered for the purposes of referencing and are not intended to limit an order or sequence of operations.

In step 202, the ETL server 25 retrieves one or more transcripts and in step 204, the ETL server 25 writes the transcript files to an indexing database (e.g., Network File System (NFS) database) that may have its contents indexed for search. The contents may be indexed as an inverted index. An inverted index (also referred to as a postings file or an inverted file) is an index data structure storing a mapping from content, such as words or numbers, to its locations in a database file, or in a document or a set of documents. There are two main variants of inverted indexes: A record level inverted index (or inverted file index or just inverted file) contains a list of references to documents for each word. A word level inverted index (or full inverted index or inverted list) additionally contains the positions of each word within a document. The latter form may offer more functionality (like phrase searches), but needs more processing power and space to be created. The purpose of an inverted index is to allow fast full text searches, at a cost of increased processing when a document is added to the database.

In some implementations, steps 202 and 204 may be performed as a part of a scheduled “cron” job or task. The scheduled cron job or task may be performed at predetermined intervals of time. Cron is a time-based job scheduler in Unix-like computer operating systems. Users may maintain software environments that use Cron to schedule jobs (commands or shell scripts) to run periodically at fixed times, dates, or intervals. It typically automates system maintenance or administration. Cron is driven by a crontab (cron table) file, a configuration file that specifies shell commands to run periodically on a given schedule. The crontab files are stored where the lists of jobs and other instructions to the cron daemon are stored. Users can have their own individual crontab files and often there is a system wide crontab file (usually in /etc or a subdirectory of /etc) that only system administrators can edit. Each line of a crontab file represents a job, and is composed of a cron expression, followed by a shell command to execute. Generally a cron job is executed when the time/date specification fields all match the current time and date.

In step 206, the ETL server 25 may read indexed chat and call log files from the indexing database and transcribe the files. In step 208, the ETL server 25 may then insert all transcript data associated with the chat and log files into the server database. The data may be stored in different rows of the server database. In some implementations, steps 206 and 208 may be performed as a part of a scheduled “cron” job or task (e.g., cron job B). Steps 202 and 204 may execute in parallel with steps 206 and 208. For example, steps 202, 204, 206 and 208 may be initiated at the same time (or simultaneously) so that they may be executed in parallel. In this way, because the above noted steps can be performed in parallel, the disclosed implementations are able to efficiently process a massive number (e.g., billions) of chat and call records in real time.

In step 210, the ETL server 25 may read indexed chat and call log files from the indexing database and in step 212 the ETL server 25 may write the records to the indexing database. Steps 210 and 212 may execute in parallel as a cron job (e.g., cron job C) with both steps 206 and 208 as well as steps 204 and 206. In some implementations, cron job C may not be completely indexed as data that is a part of this job may not be relevant to a reporting system and may have resulted in a large indexed data set. In some implementations, there may be a “catchup” process for all three processes (cron job A, B and C), which can run at 25 hour delay (or any other delay) these same three processes. In this way, there can be additional three sets of processes which can run at a particular delay to ensure data is completely captured. In some implementations, there may be some additional open sessions which may come later after 24 hours when these processes are closed. Thus, an example production environment can, in total, include six processes (two sets of each cron job A, B and C) of which one is current (e.g., 6 hours behind) and the other catch up (e.g., running 25 hours behind).

In step 214, the ETL server 25 may search chat and log files in the indexing database. Such a search operation may be performed responsive to a search query via a web interface or dashboard. In step 216, the ETL server 25 may fetch data related to the web interface of the dashboard. Such data may include search analytics or chat analytics data. Search analytics may include search keywords, frequency of use of those keywords, times at with particular searches are performed etc. Chat analytics data may include times at which chats are initiated, durations of chats, names of users initiating the chats and customer services agents involved in the chats. In step 218, the ETL server 25 may also fetch chat and voice data to satisfy the search queries of step 214. In step 220, the ETL server 25 may also fetch dashboard data related to order confirmation numbers. For example, during a chat or voice session a user may place an order for a service or product with a customer service agent. An order confirmation number may be associated with such a purchase. The order confirmation number may serve as an identifier to retrieve chat and call logs associated with a customer service session that led to the purchase. Steps 214-220 may execute in parallel as a cron job (e.g., cron job D) with other cron jobs (e.g. cron jobs A, B and C).

In step 222, chat and voice data may be selected or identified for display in a dashboard in the server database. In step 224, chat and log files may be stored using a protocol, such as File Transfer Protocol (FTP). Steps 222 and 224 may execute in parallel as a cron job (e.g., cron job E) with other cron jobs (e.g. cron jobs A, B, C and D). In some implementations, cron job A, B, C and D may execute every thirty minutes or at any other predetermined time duration (e.g., every hour, every week, etc.). Cron job E may execute automatically every 24 hours. These predetermined times may be determined by an administrator at the ETL server 25.

In this way, because the above noted operations of cron jobs A, D, C, D and E can be performed in parallel, the disclosed implementations are able to efficiently process a massive number (e.g., billions) of chat and call records in real time. The disclosed implementations provide an effective ETL process that can process meta-data elements/tags while also enabling search capabilities across this data with powerful query types phrase queries, wildcard queries, and sorting by any field.

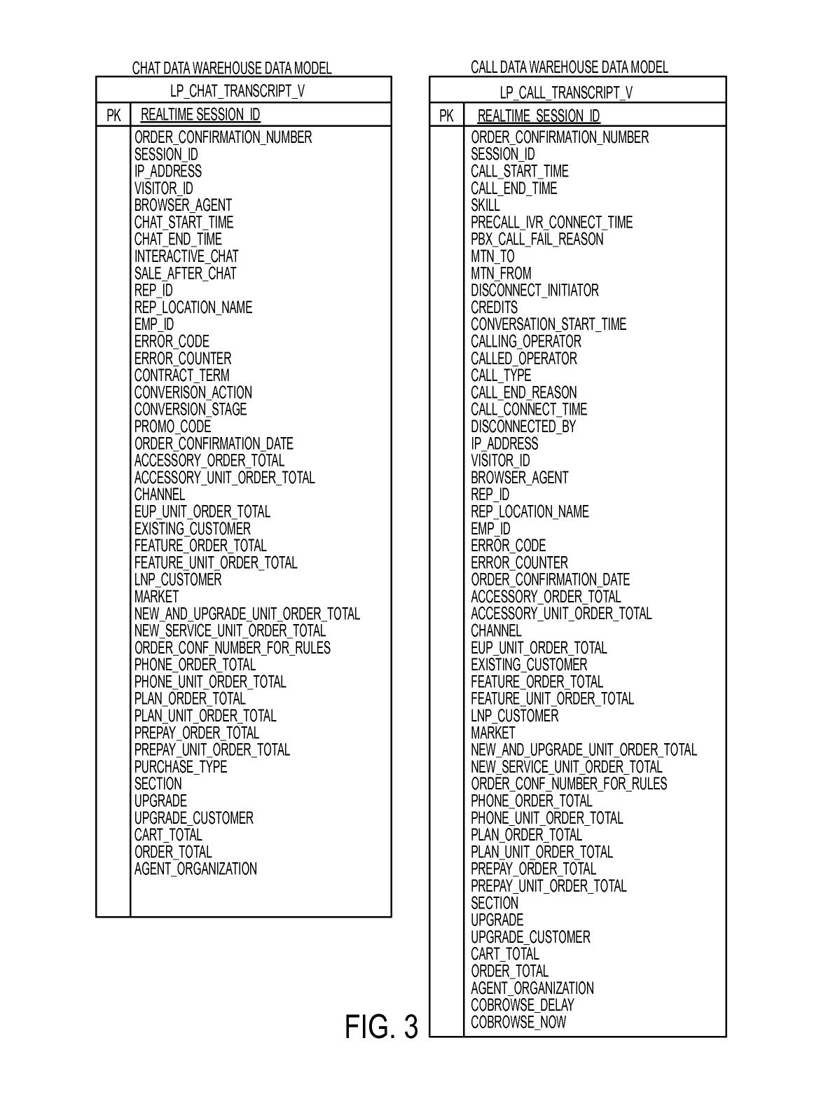

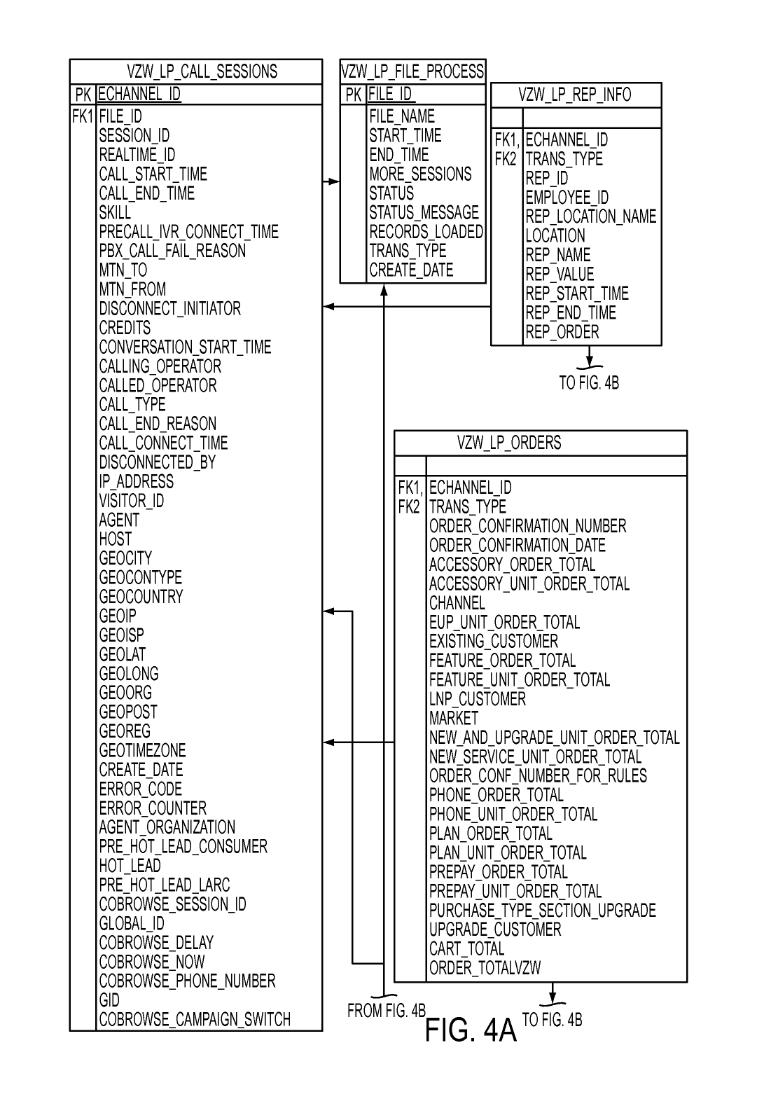

FIGS. 3, 4A and 4B illustrate an example data models that are associated with the ETL framework in accordance with the disclosed implementations. In software engineering, a data model can be a description of the objects represented by a computer system together with their properties and relationships; these are typically “real world” objects such as products, suppliers, customers, and orders. A data model may also be a collection of concepts and rules used in defining data models: for example the relational model uses relations and tuples, while the network model uses records, sets, and fields. Data models are often used as an aid to communication between the business people defining the requirements for a computer system and the technical people defining the design in response to those requirements. They are used to show the data needed and created by business processes. A data model may explicitly determine the structure of data. For example, with reference to FIG. 3, the chat data warehouse data model may include values related to an ORDER_CONFIRMATION_NUMBER, SESSION_ID, IP_ADDRESS, VISITOR_ID and BROWSER_AGENT, etc. Also, call data warehouse data model may include an ORDER_CONFIRMATION_NUMBER, SESSION_ID, CALL_START_TIME, CALL_END_TIME, etc. Referring to FIG. 4A, a call sessions database may include values referring to FILE_ID, SESSION_ID, REALTIME_ID, CALL_START_TIME, CALL_END_TIME, etc. Referring to FIG. 4B, a chat session ID may also include REALTIME_ID, CHAT_START_TIME and CHAT_END_TIME. Data models are specified in a data modeling notation, which is often graphical in form. A data model can be sometimes referred to as a data structure, especially in the context of programming languages. Data models are often complemented by function models, especially in the context of enterprise models.

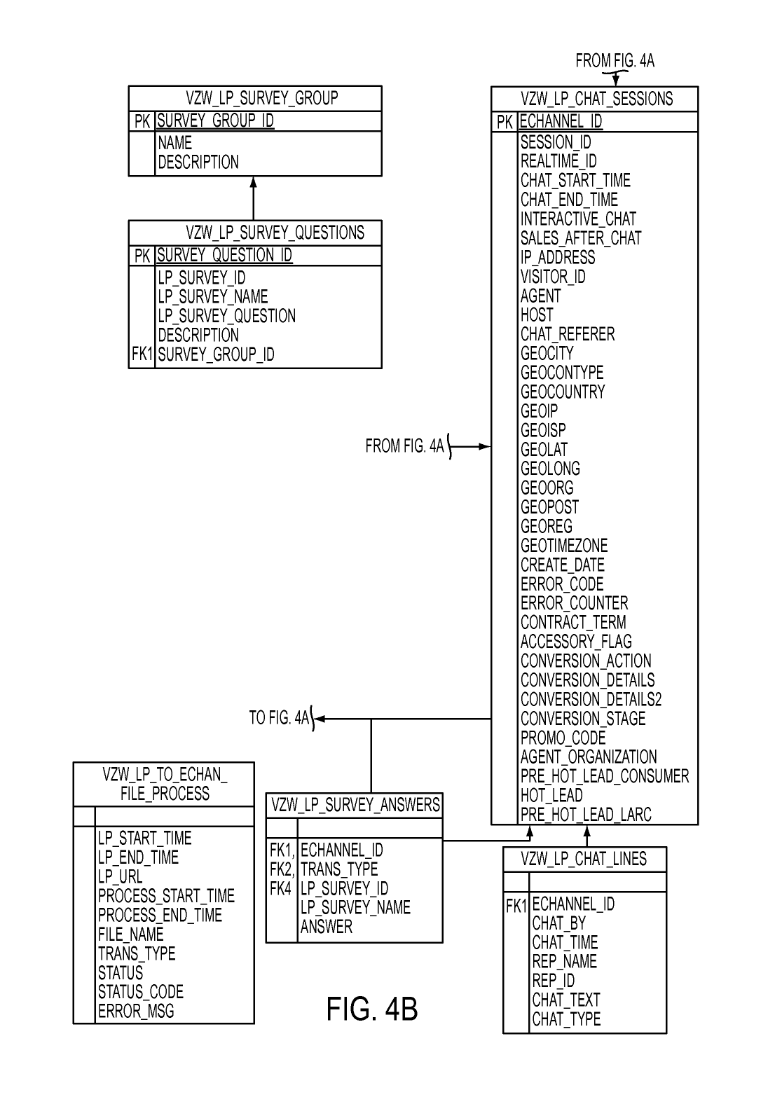

FIGS. 5, 6 and 7 illustrate exemplary tasks performed between different components associated with the cron jobs discussed above.

Referring to FIG. 5 cron job A may be executed every half hour or thirty minutes (stage 502). Batch processor may interact with a customer service database to check a last processing run (step 504), format any URL strings to check any operation start and end dates (step 506) and get retrieve transcripts and XML records (step 508). Any XML records associated with the chat records may be received in steps 510 and 512. The batch processor may parse the XML to determine any validation errors and update a database for file statistics (step 514). The batch processor may then update chat related files in the database (step 516) and update the database with any file statistics (step 518).

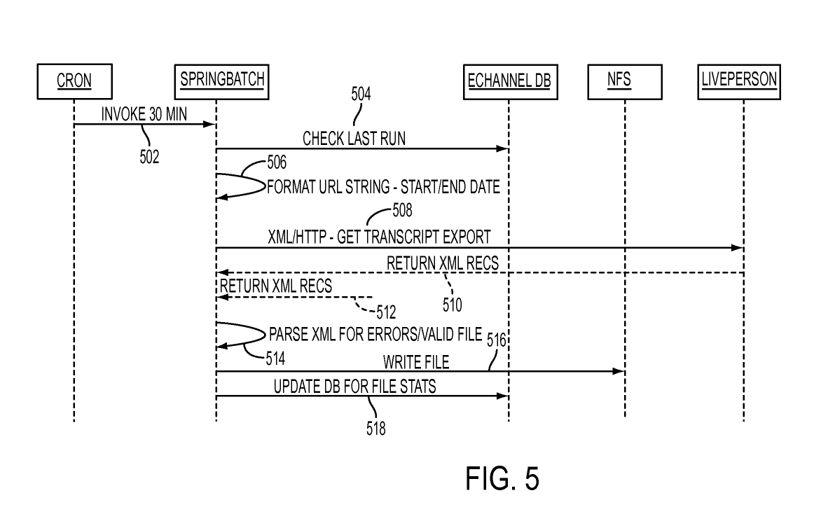

Referring to FIG. 6, cron job B may be executed every half hour (stage 602) after chat and call log files are selected for processing (step 604) and may loop to ensure that all files are processed until there are no further files left to process (step 606). The batch processor may read from the NFS a file to process (step 608) and may parse XML associated with the file (step 610). In addition, the batch processor may provide commands that include batch insertion of records to the server database (step 612), updating a file statistics table (step 614), writing a log file for each XML file (step 616), as well as archiving XML and log files (step 618).

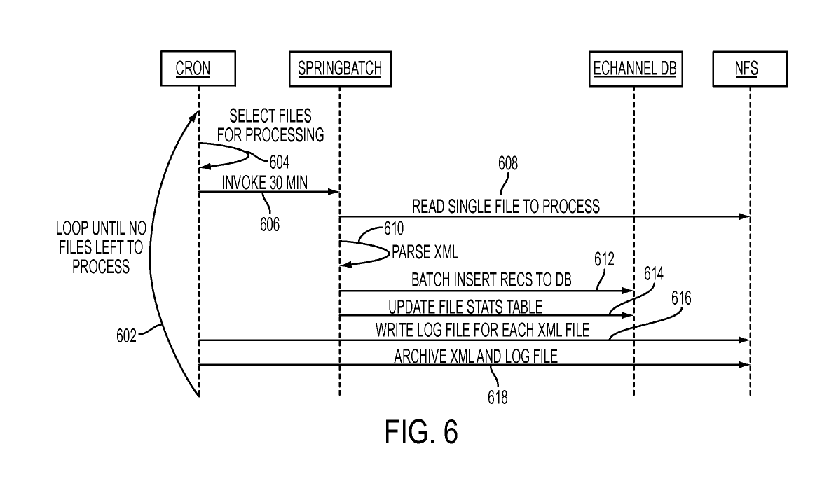

Referring to FIG. 7 and for example, cron job C may be executed every 24 hours or on a daily basis (stage 702). Cron job C may be performed by a batch processor (e.g., SpringBatch). Batch processing is the execution of a series of programs (“jobs”) on a computer without manual intervention. Jobs are set up so they can be run to completion without human interaction. All input parameters are predefined through scripts, command-line arguments, control files, or job control language. This is in contrast to “online” or interactive programs which prompt the user for such input. A program takes a set of data files as input, processes the data, and produces a set of output data files. This operating environment is termed as “batch processing” because the input data are collected into batches or sets of records and each batch is processed as a unit. As illustrated in FIG. 7, example communications between the batch processor and the server database (e.g., eChannelDB) include checking a database and fetching records from the server database. Additionally, the batch processor may write files to the file system (e.g., NFS). The cron jobs may also communicate directly with the NFS via FTP. The batch processor may check a last processing run (step 704), format queries (step 706) and get retrieve transcripts and XML records (step 708). The batch processor may create files (e.g., chat files) for a data warehouse (step 710). The batch processor may then update chat related files in the database (step 712) and update the database with any file statistics (step 714). Files may be provided over file transfer protocol (FTP) to the data warehouse (step 716).

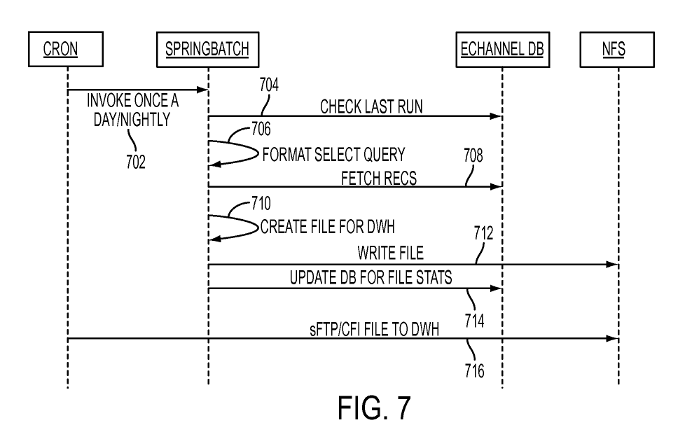

FIG. 8 illustrates an analytics dashboard that may display data provided by the ETL server to a client computing device. Referring to FIG. 8, based on start date and end date input parameters the ETL server 25 may retrieve data for Gross Adds (ETM), Upgrades (ETM) and Accessories (ETM) one by one. Gross Adds include data regarding any additions that may be made to databases. Upgrades (ETM) include data related to mobile station upgrades and accessories (ETM) include data related to any Accessories purchased by the user.

The following example URL may be used to fetch data from Middle Tier (MT). The middle tier enables users to access intelligence data and functionality via a Web browser. This tier provides Web-based interfaces for report creation and information distribution, while passing analysis and processing requests to servers.
public static const WEB_CHAT_SALES_SUMMARY:String=“https://ech.vzwcorp.com/echreports/webchat/webchatsales.json”;

For each call, the ETL server 25 may fire a separate event to get Gross Adds, Upgrades and Accessories and passing groupName which may be a variable used to identify a group of data related to a particular chat session. To do so, for example, the ETL server may execute the following commands:
params.groupName=“webChatSalesAddSummary”;
broadcast(new ChatSalesSummaryEvent(params));
params.groupName=“webChatSalesUpgradesSummary”;
broadcast(new ChatSalesSummaryUpgradesEvent(params));
params.groupName=“webChatSalesAcceSummary”;
broadcast(new ChatSalesSummaryAcceEvent(params));

Referring to FIG. 8, for each interface grid may be associated with a separate data source. Each grid may include separate data sources to display/compare graphs.

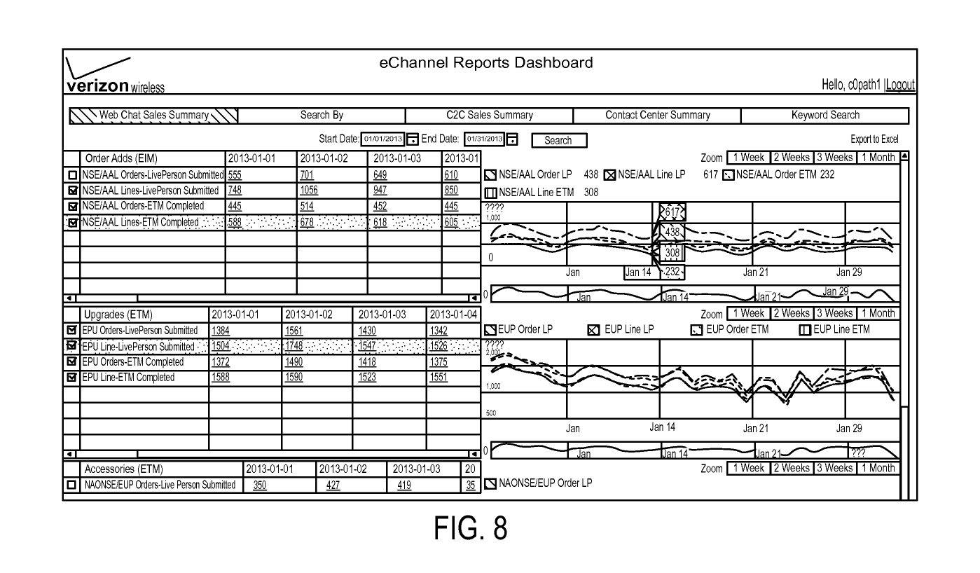

FIG. 9 illustrates an exemplary order confirmation page. Based on a particular date of an order, the ETL server 25 can retrieve data for order confirmation using a “ChatSalesOrderConfirmEvent.”

An example URL for such retrieval is:
public static const WEB_CHAT_SALES_ORDER_CONFIRMATION:String=“https://ech.vzwcorp.com/echreports/webchat/orderconfirmations.json”;

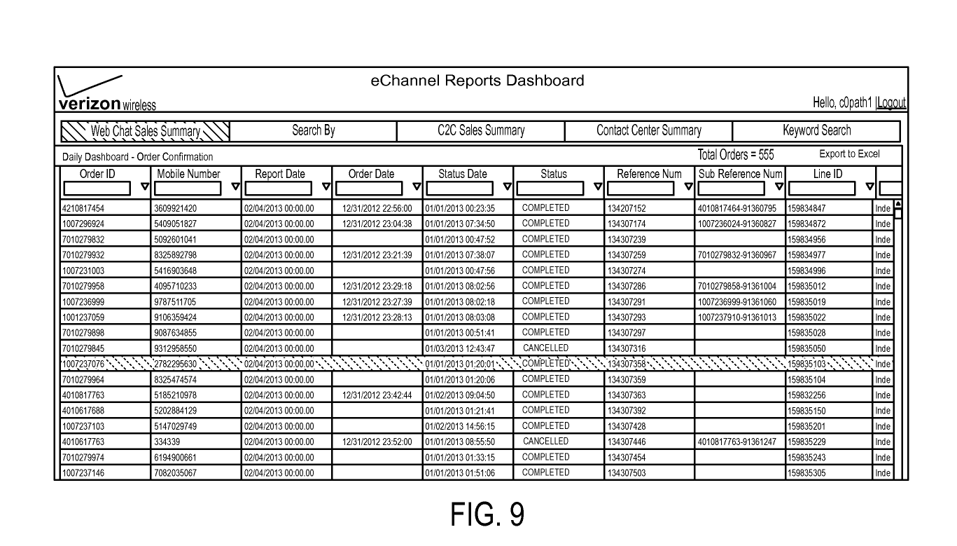

FIG. 10 illustrates an exemplary order details page. Based on particular order confirmation the ETL server 25 can retrieve data from different databases (e.g., eChannel DB, CIS, WFM, Chat Transcripts and Survey) using ChatSalesOrderDetailsEvent.

An example URL for such retrieval is:
public static const WEB_CHAT_{—} SALES_{—} ORDER_{—} DETAILS: String=“https://ech.vzwcorp.com/echreports/echannelData/orderdetails.json”;

In some implementations, the ETL server may manipulate results based on groupName. Examples of the groupName passed for each request include, but are not limited to:
params.groupName=“webChatSalesEchannelDetails”;
params.groupName=“webChatSalesCISDetails”;
params.groupName=“webChatSalesCISPlansDetails”;
params.groupName=“webChatSalesCISEquipDetails”;
params.groupName=“webChatSalesWFMDetails”;
params.groupName=“webChatSalesTranscriptsDetails”;
params.groupName=“webChatSalesTranscriptsDetails”;
params.groupName=“webChatSalesSurveyDetails”;

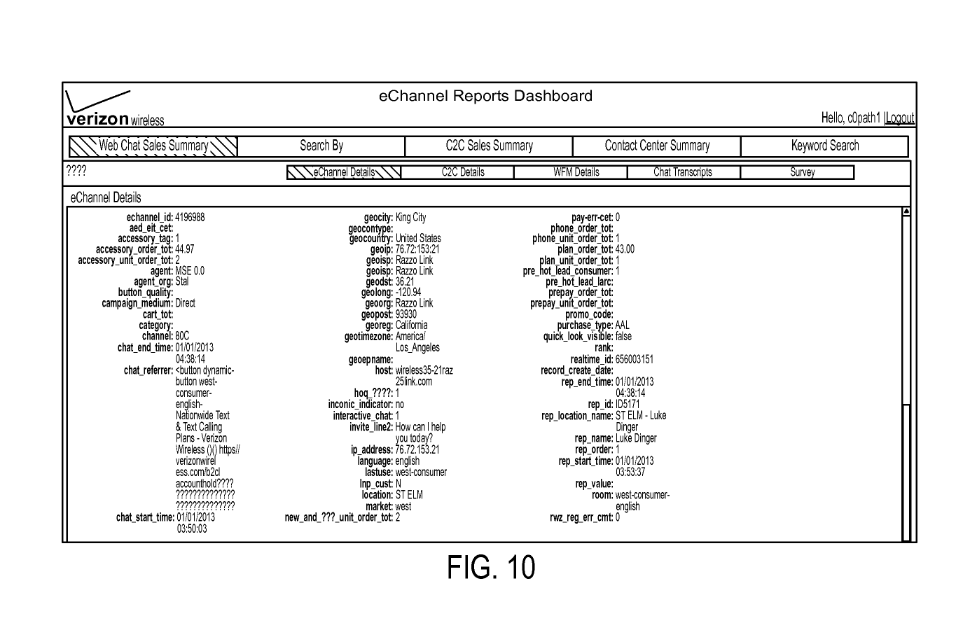

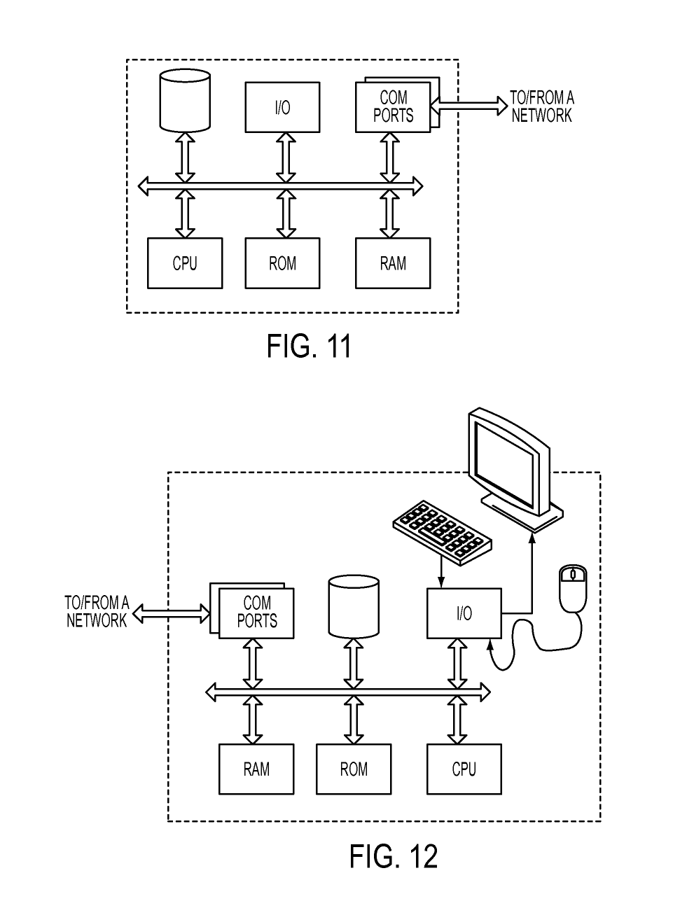

FIGS. 11 and 12 provide functional block diagram illustrations of general purpose computer hardware platforms. FIG. 11 illustrates a network or host computer platform, as may typically be used to implement a server. FIG. 12 depicts a computer with user interface elements, as may be used to implement a personal computer or other type of work station or terminal device, although the computer of FIG. 12 may also act as a server if appropriately programmed. For example, the computer and platforms illustrated in FIG. 11 and FIG. 12 may be implemented as the ETL server 25. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 12). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of the ETL processing framework outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the ETL processing framework into the computer platform of the ETL server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the ETL server, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
retrieving, at a server, chat and call log files from a customer service database;
automatically storing the chat and call log files into a server database;
receiving, one or more queries related to the chat and call log files in the server database, wherein the queries include one or more of phrase queries or wildcard queries, wherein the chat and call log files include meta-data elements characterizing data in the chat and call log files;
processing the one or more queries using the meta-data elements to generate results satisfying the one or more queries as the chat and call log files are being extracted, transformed and loaded into the server database; and
providing the results of the queries to a client computing device for display,
wherein the retrieving, the automatically including, the receiving and the processing are performed in parallel at the server.

2. The method of claim 1, wherein the fetching and the automatically including are performed automatically at predetermined intervals of time.

3. The method of claim 1, wherein the chat and the call log files include meta data elements or tags used for the processing of the one or more queries.

4. The method of claim 1, where the automatically including further comprises:
reading the retrieved chat and call log files;
generating transcriptions of the retrieved chat and call log files; and
automatically storing the transcriptions into the database.

5. The method of claim 1, further comprising:
displaying a summary of a chat in a dashboard;
displaying chat parameters associated with the chat as a function of time; and
displaying a current status of each chat conversation of the chat, wherein the current status includes a completed or a canceled status.

6. The method of claim 5, further comprising:
receiving a date range associated with the chat and the call log files;
grouping the chat logs based on the received date range; and
displaying the chat logs based on the grouping in the dashboard.

7. The method of claim 5, further comprising:
determining one or more customer service centers associated with the chat and the call log files; and
providing for display the chat and the call log files in the user interface with identifications of their customer service centers.

8. A server comprising:
a communication interface configured to enable communication via a mobile network;
a processor coupled with the communication interface;
a storage device accessible to the processor; and
an executable program in the storage device, wherein execution of the program by the processor configures the server to perform functions, including functions to:
retrieve, at the server, chat and call log files from a customer service database;
automatically store the chat and call log files into a server database;
receive, one or more queries related to the chat and call log files in the server database, wherein the queries include one or more of phrase queries or wildcard queries, wherein the chat and call log files include meta-data elements characterizing data in the chat and call log files;
process the one or more queries using the meta-data elements to generate results satisfying the one or more queries as the chat and call log files are being extracted, transformed and loaded into the server database; and
provide the results of the queries to a client computing device for display,
wherein the retrieving, the automatically including, the receiving and the processing are performed in parallel at the server.

9. The server of claim 8, wherein the fetching and the automatically including are performed automatically at predetermined intervals of time.

10. The server of claim 8, wherein the chat and the call log files include meta data elements or tags used for the processing of the one or more queries.

11. The server of claim 8, where the automatically including further comprises:
reading the retrieved chat and call log files;
generating transcriptions of the retrieved chat and call log files; and
automatically storing the transcriptions into the database.

12. The server of claim 8, wherein execution of the program by the processor configures the server to perform functions, including functions to:
display a summary of a chat in a dashboard;
display chat parameters associated with the chat as a function of time; and
display a current status of each chat conversation of the chat, wherein the current status includes a completed or a canceled status.

13. The method of claim 12, wherein execution of the program by the processor configures the server to perform functions, including functions to:
receive a date range associated with the chat and the call log files;
group the chat logs based on the received date range; and
display the chat logs based on the grouping in the dashboard.

14. The method of claim 12, wherein execution of the program by the processor configures the server to perform functions, including functions to:
determine one or more customer service centers associated with the chat and the call log files; and
provide for display the chat and the call log files in the user interface with identifications of their customer service centers.

15. A non-transitory computer-readable medium comprising instructions which, when executed by one or more computers, cause the one or more computers to:
retrieve, at the server, chat and call log files from a customer service database;
automatically store the chat and call log files into a server database;
receive, one or more queries related to the chat and call log files in the server database, wherein the queries include one or more of phrase queries or wildcard queries, wherein the chat and call log files include meta-data elements characterizing data in the chat and call log files;
process the one or more queries using the meta-data elements to generate results satisfying the one or more queries as the chat and call log files are being extracted, transformed and loaded into the server database;
provide the results of the queries to a client computing device for display,
wherein the retrieving, the automatically including, the receiving and the processing are performed in parallel at the server.

16. The non-transitory computer-readable medium of claim 15, wherein the fetching and the automatically including are performed automatically at predetermined intervals of time.

17. The non-transitory computer-readable medium of claim 15, wherein the chat and the call log files include meta data elements or tags used for the processing of the one or more queries.

18. The non-transitory computer-readable medium of claim 15, where the automatically including further comprises:
reading the retrieved chat and call log files;
generating transcriptions of the retrieved chat and call log files; and
automatically storing the transcriptions into the database.

19. The non-transitory computer-readable medium of claim 15, further comprising instructions which, when executed by the one or more computers, cause the one or more computers to:
display a summary of a chat in a dashboard;
display chat parameters associated with the chat as a function of time; and
display a current status of each chat conversation of the chat, wherein the current status includes a completed or a canceled status.

20. The non-transitory computer-readable medium of claim 19, further comprising instructions which, when executed by the one or more computers, cause the one or more computers to:
receive a date range associated with the chat and the call log files;
group the chat logs based on the received date range; and
display the chat logs based on the grouping in the dashboard.
